(19) United States
(12) Patent Application Publication
(10) Pub. No.: US 2003/0233666 A1
(43) Pub. Date: Dec. 18, 2003

(54) Digital broadcast recording apparatus and digital broadcasting system equipped with the same

(75) Inventors: Takehiro Onomatsu, Osaka (JP); Tatsuo Miyagawa, Osaka (JP)

Correspondence Address: CROWELL & MORING LLP, INTELLECTUAL PROPERTY GROUP, P.O. BOX 14300, WASHINGTON, DC, 20044-4300, US

(73) Assignee: Funai Electric Co., Ltd.

(21) Appl. No.: 10/449,501

(22) Filed: Jun. 2, 2003

(30) Foreign Application Priority Data
Jun. 3, 2002 (JP) 2002-161960

(51) Int. Cl. H04N 7/173

(52) U.S. Cl. 725/134; 725/142; 725/89

(57) ABSTRACT

Broadcast signals carrying video and audio data are transmitted after encoding and compression process at a broadcast station and then stored temporarily in a hard disk recorder/player in a broadcast recording apparatus. The broadcast signal includes a row of video and audio packets having no empty spaces for synchronization with the actual program playback speed. The playback of a program is controlled with a timing data which is carried in each of the video and audio packets. Accordingly, the broadcast signals of the program transmitted at a speed faster than the actual program playback speed are temporarily stored and when desired, can be played back at any time.

### BACKGROUND OF THE INVENTION

The present invention relates to a digital broadcast recording apparatus and a digital broadcasting system equipped with the same.

Digital broadcasting systems for transmission of digital signals have been started and spread very rapidly. Such digital broadcasting systems are known where video and audio data of broadcast signals are compressed and transmitted for broadcasting of multiple programs (sub-channels) simultaneously over a single band of frequencies. More particularly, the broadcast signals of compressed form received by a digital broadcast receiver are saved in a buffer and then played back in a sequence based on a timing data accompanied to the signals, and output to a monitor or any other display device. When the transmission speed of the broadcast signals is faster than the actual program playback (proceeding) speed, a buffer overflow may occur in the broadcast receiver. For compensation, the broadcast signals are adjusted in the size of video and audio packet data, specifically, by inserting empty spaces to provide non-data packets so that their transmission speed is synchronized with the actual program playback speed.

FIG. 5 illustrates a set of digital broadcast program channels released from a broadcast station and a row of packets in a length of time T3 of its broadcast signal expanded along the time base direction. Denoted by 5 ch is the main channel of the digital broadcast signal. The main channel comprises one or more sub-channels. A particular band of frequencies is assigned to each broadcast station which thus releases a sub-channel multiplexed or time-division form of the broadcast signal. For example, the main channel of 5 ch carries a standard definition (SD) program B on a sub-channel of 5.1 ch and another SD program C on another sub-channel of 5.2 ch during a period from 19:00 to 20:00. After 20:00, three different SD programs D, E, and F are broadcasted on the sub-channel of 5.1 ch, the sub-channel of 5.2 ch, and a sub-channel of 5.3 ch respectively. It is also possible to provide a time-division form of a single sub-channel of the broadcast signal. For example, during a period from 18:00 to 19:00, a high definition (HD) program A may be released on the sub-channel 5.1 ch.

The broadcast signal on each sub-channel comprises time-division packets at a given frequency band assigned to its broadcast station. More particularly, the broadcast signal consists of video/audio packets 52a, 52b . . . , 53a, 53b . . . carrying video and audio data of the sub-channel and empty spaces 54a, 54b . . . carrying no data. As illustrated, in a period T3, a group of a video/audio packet 52a of the program B (at 5.1 ch) and a video/audio packet 53a of the program C (at 5.2 ch) with an empty space 54a are sequentially transmitted as followed by another group of a video/audio packet 52b of the program B (at 5.1 ch) and a video/audio packet 53b of the program C (at 5.2 ch) with an empty space 54b. The empty spaces 54a, 54b . . . form a free band area 50 in the broadcast signal.

Also, there have been proposed a variety of broadcasting systems and recording apparatuses in the field of digital broadcast service. For example, a data transmitter/receiver system is known where with the transmitter providing data signals at free areas of the frequency band, the receiver saves the data signals sequentially and upon having received an entire stream of data, reproduces the data signals (for example, Japanese Laid-open Patent Publication Nos. 2001-359061 or 2001-298687). Similarly, another digital broadcasting system is proposed where when a digital broadcast signal accompanied with a time stamp which represents the timing for playback is transmitted by the transmitter over the free spaces of the broadcast frequency band, it is saved in a hard disk and then played back at the timing of the time stamp by the receiver (for example, Japanese Laid-open Patent Publication No. 2002-16879). A further broadcasting system is known where when the broadcast signals are released from a station at longer intervals of time than the actual playback speed of the program, they are saved in a hard disk and then played back by the receiver (for example, Japanese Laid-open Patent Publication No. HEI 10-215440). Moreover, a broadcast recording apparatus is proposed for saving the broadcast signal received and producing from the broadcast signal a time management data which is then used for operating particular playback actions including jump playback and fast forward playback (for example, Japanese Laid-open Patent Publication No. 2001-86431).

In any conventional digital broadcasting system, the broadcast receiving apparatus includes a buffer which is designed for temporarily storing the broadcast signals received, although commonly has a storage capacity of data only enough to save temporarily and read out in a sequence the broadcast signals which have been transmitted at a speed substantially equal to the actual program playback speed. Accordingly, it fails to store a large amount of the broadcast signals. It is hence necessary for the conventional broadcasting system using such a broadcast receiving apparatus to provide the broadcast signals with empty spaces for avoiding an overflow of the buffer in the broadcast receiving apparatus before transmitting the broadcast signals at a speed substantially equal to the actual program playback speed.

If the broadcast signals are released from a station at a speed faster than the actual program playback speed, they can hardly be received by the convention broadcast receiving apparatus which has no storing means for storing a large amount of data. Accordingly, the temporal storage of the broadcast signals carrying from the beginning to the end of a program will be disabled thus permitting no playback by the user.

The conventional digital broadcasting systems disclosed in Japanese Laid-open Patent Publication Nos. 2001-359061, 2001-298687, 2002-16879, and HEI 10-215440 all are arranged to insert an extra program into the empty spaces in the broadcast signals. This will hence increase the total time of signal transmission when the broadcast signals carries an HD mode program having a large amount of data.

### SUMMARY OF THE INVENTION

The present invention has been developed for solving the foregoing problems and its object is to provide a digital broadcast recording apparatus and a digital broadcasting system employing the same where the broadcast signals of a program transmitted at a speed faster than the actual playback speed of the program are temporarily stored and when desired, can be reconstructed for playback.

For achievement of the object, an aspect of the present invention provides a digital broadcast recording apparatus having a receiver which receives digital broadcast signals which have been encoded and transmitted from a broadcast station, a storing means which stores the broadcast signals received by the receiver, and a decoder which decodes the broadcast signals stored in the storing means, the digital broadcast recording apparatus comprising: the digital broadcast signals being transmitted at a speed which is different from an actual playback speed of the program and containing a timing data for the actual playback speed, a storage controlling means which directs the storing means to temporarily store the broadcast signals received by the receiver; and a playback controlling means which reconstructs the broadcast signals stored in the storing means with the use of the timing data and directs the decoder to decode the broadcast signals, wherein the broadcast signals are temporarily stored in the storing means and when desired, can be reconstructed for playback.

This allows the broadcast signals transmitted at a speed different from the actual program playback speed to be temporarily saved in the storing means by the action of the storage controlling means, reconstructed by the action of the playback controlling means, and decoded by the action of the decoder for playback. The transmission speed of the broadcast signals may be either faster or slower than the actual program playback speed. When the broadcast signals are transmitted at a speed higher than the actual program playback speed, their recording time on the digital broadcast recording apparatus can be minimized. Also, as the broadcast signals are reconstructed by the playback controlling means with the use of the timing data contained in the signals, they can be prevented from fault actions during the playback such as forwarding error or frame drop, thus ensuring the normal playback of the program.

Preferably, in the digital broadcast recording apparatus, the digital broadcast signals are encoded and compressed at the station and transmitted continuously or intermittently over empty spaces in a frequency band assigned to the station.

Preferably, the digital broadcast recording apparatus further comprises a notifying means which confirms the storage of the broadcast signals in the storing means and notifying a user, during the recording, of the length of the program which can be played back.

Preferably, the digital broadcast recording apparatus further comprises an entry means which allows a user to enter various commands which include a recording command and a playback command.

Another aspect of the present invention provides a digital broadcasting system including a digital broadcast apparatus having an encoder which encodes video and audio signals of each program to digital forms and a transmitting means which transmits the digital signals produced by the encoder, and a digital broadcast recording apparatus having a receiver which receives the digital signals from the digital broadcast apparatus, a storing means which stores the digital signals received by the receiver, and a decoder which decodes the digital signals stored in the storing means, the system comprising: the digital signals being transmitted from the transmitting means at a speed which is different from an actual playback speed of the program, the digital signals containing a timing data for the actual playback speed, and the digital broadcast recording apparatus including a storage controlling means which directs the storing means to temporarily store the broadcast signals received by the receiver, and a playback controlling means which reconstructs the broadcast signals stored in the storing means with the use of the timing data and directs the decoding means to decode the broadcast signals, wherein the broadcast signals are temporarily stored in the storing means and when desired, can be reconstructed for playback.

Preferably, in the digital broadcasting system, the digital broadcast signals are transmitted continuously or intermittently over empty spaces in a frequency band assigned to the station.

### BRIEF DESCRIPTION OF THE DRAWINGS

FIG. 1 is a block diagram of an electrical arrangement of a broadcast transmitting apparatus in a digital broadcasting system showing one embodiment of the present invention;

FIG. 2 is a block diagram of an electrical arrangement of a broadcast recording apparatus in the digital broadcasting system;

FIG. 3A illustrates a row of packets with an exemplary program assignment in the digital broadcasting system, FIG. 3B illustrates another row of packets with another exemplary program assignment in the same;

FIG. 4 is a flowchart showing the action of a controller in the broadcast recording apparatus from the reception of a broadcast signal to the playback of its program; and

FIG. 5 illustrates a row of packets in a time period T3 enlarged along the time base direction with a program assignment in a conventional broadcasting system.

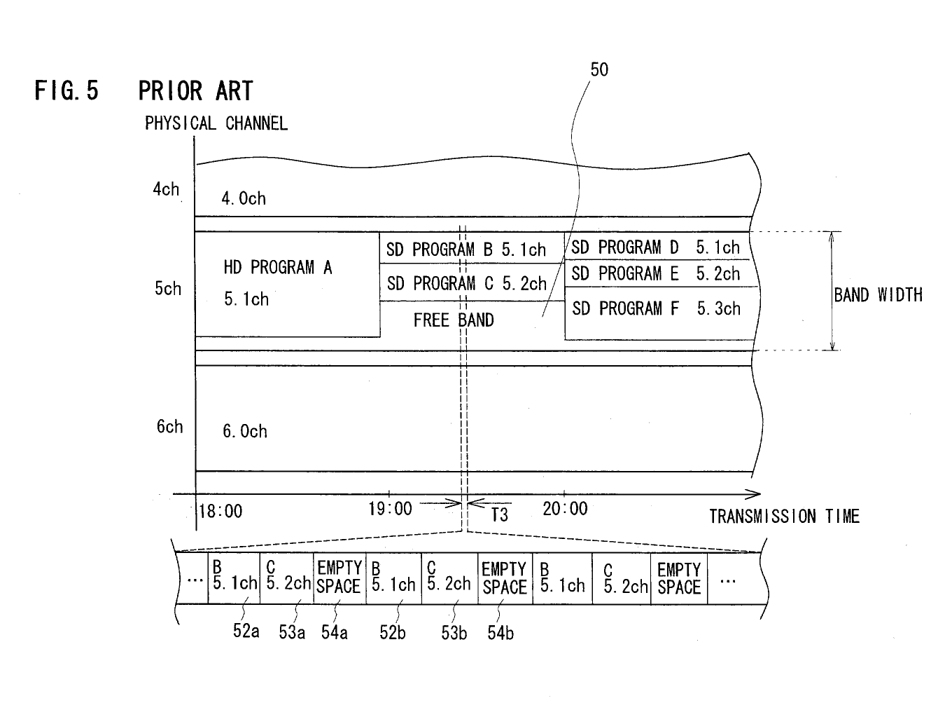

### DETAILED DESCRIPTION OF THE PREFERRED EMBODIMENTS

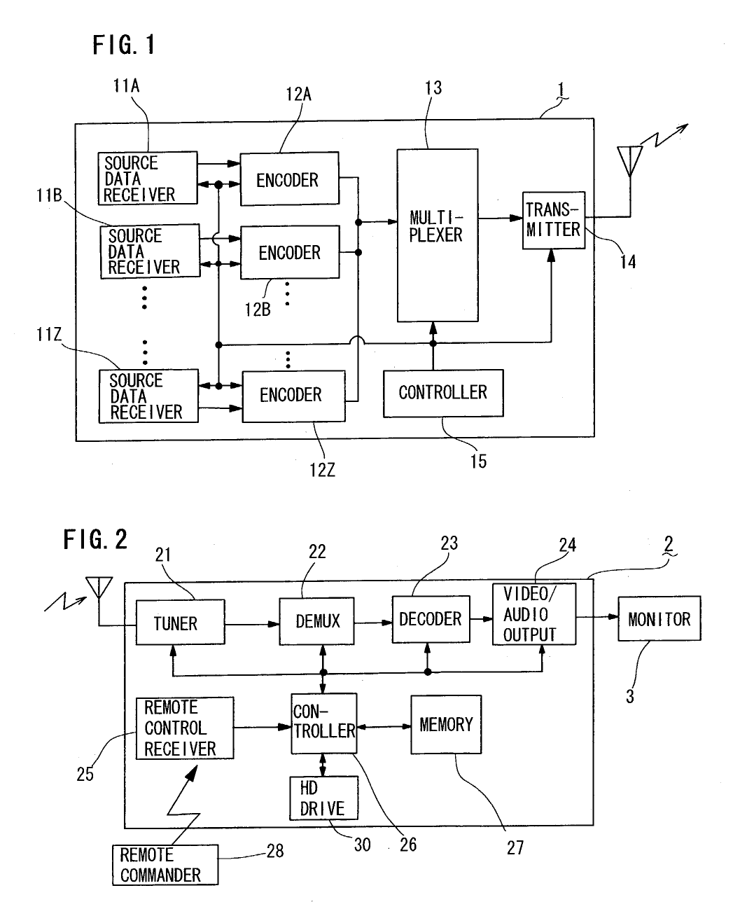

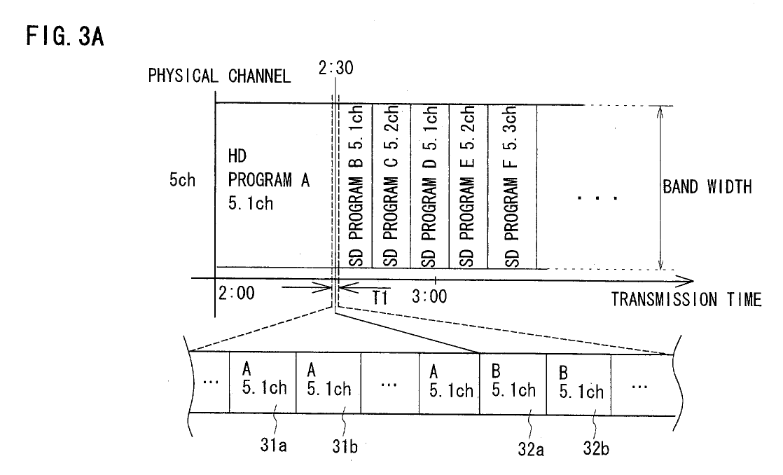

A digital broadcasting system according to one embodiment of the present invention will be described referring to the relevant drawings. FIGS. 1 and 2 illustrate a broadcast transmitting apparatus and a broadcast recording apparatus respectively provided in the digital broadcasting system. This system allows broadcast signals transmitted by the broadcast transmitting apparatus 1 at a speed different from the actual playback speed of the program to be received and temporarily saved in the broadcast recording apparatus 2 for playback thereafter. The broadcast transmitting apparatus 1 is provided for producing and transmitting broadcast signals which comprises a group of source data receivers 11 A to 11Z, a group of encoders 12A to 12Z, a multiplexer 13, a transmitter 14, and a controller 15. The source data receivers 11 A to 11Z are designed for receiving video and audio source data in the broadcast signals. The encoders 12A to 12Z are provided for encoding and compressing the source data received by their respective source data receivers 11A to 11Z. The action of encoding and compressing may conform to the MPEG-2 standards. The multiplexer 13 is designed for multiplexing encoded and compressed signal outputs of the encoders 12A to 12Z to produce a broadcast signal. The broadcast signal produced by the multiplexer 13 is then transmitted from the transmitter 14. The controller 15 is provided for controlling the action of each component in the broadcast transmitting apparatus 1.

The broadcast recording apparatus 2 is provided for temporarily saving the broadcast signals received from the broadcast transmitting apparatus 1 and providing a monitor 3 with the broadcast signals for display, which comprises a tuner (receiver) 21, a demultiplexer (storage means, referred to as an HD drive hereinafter) 22, a decoder (decoder) 23, a video/audio output 14, a remote control receiver 25, a controller (storage controlling means, notifying means, playback controlling means) 26, a memory 27, a remote commander (entry means) 28, and a hard disk recorder/player 30. The tuner 21 is designed for receiving the broadcast signals from the broadcast transmitting apparatus 1. The broadcast signals received by the tuner 21 are demultiplexed by the demultiplexer 22 and stored on a hard disk and when desired, played back by the HD drive 30. The decoder 23 is designed for decoding the broadcast signals stored in the HD drive 30. The video/audio output 24 converts the decoded signals from the decoder 23 into video and audio signals which can be played back by the monitor 3. The remote control receiver 25 is provided for receiving command signals of an infrared ray form from the remote commander 28 and transferring them to the controller 26. The controller 26 is operated with an action program stored in the memory 27 for controlling the action of each component in the apparatus 2. The remote commander 28 is provided for permitting the user to enter its desired commands and transmitting an infrared ray signal form of the commands.

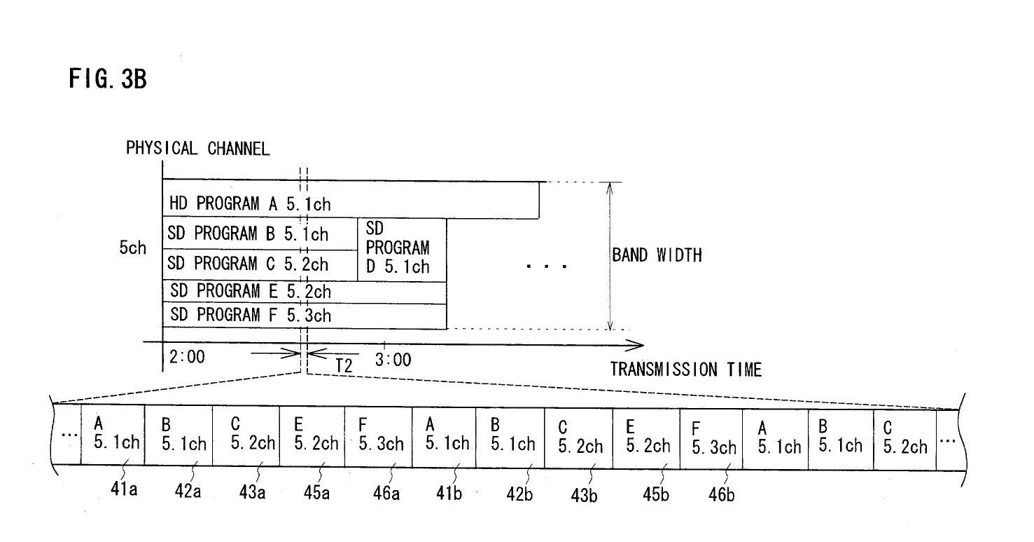

FIGS. 3A and 3B illustrate two kinds of packets of the broadcast signal in time periods T1 and T2 enlarged along the time base direction with program assignments in the above described digital broadcasting system. As the broadcast signal is transmitted at a speed different from the actual program playback speed in the system, it can contain more programs to be broadcasted particularly through a less-busy period such as a midnight. For example, each program can be broadcasted in its dedicated period of time as shown in FIG. 3A. More specifically, a row of video/audio packets 31a, 31b . . . of the program A are first released as followed by another row of video/audio packets 32a, 32b . . . of the program B. Particularly since the empty spaces of the conventional system are filled with the video/audio packets 31a, 31b . . . and 32a, 32b . . . to be transmitted, the speed of transmitting the broadcast signal is faster than the actual playback speed of the program. It is noted that the video/audio packets 31a, 31b . . . carry a piece of information indicating that the program A has been broadcasted over the channel of 5.1 ch from 2:00 to 2:30 as well as the main video and audio data and its related data about the actual speed for playing back the program. The video/audio packets 32a, 32b . . . are also identical in the function.

This system can also broadcast two or more programs at once as shown in FIG. 3B. For example, one HD program A may be broadcasted together with other SD programs B, C, E, and F. A series of the packets from the video/audio packet 41a of the program A to the video/audio packet 46a of the program F is followed by another series of the packets from the video/audio packet 41b of the program A to the video/audio packet 46b of the program F. As the packets of different programs are transmitted in a sequence, the speed of transmission can be slower than the actual program playback speed.

In each broadcasting case of the two different program assignments shown in FIGS. 3A and 3B, a row of the video/audio packets can efficiently be transmitted with no need of providing the empty spaces for synchronization with the actual program playback speed in the conventional broadcasting system. Also, while each of the programs is continuously broadcasted in the above description, it may be released intermittently in short intervals between the other programs. In any case, as the broadcast signals of each program are separately received and temporarily saved in the HD drive 30, they can easily be joined to one another before played back.

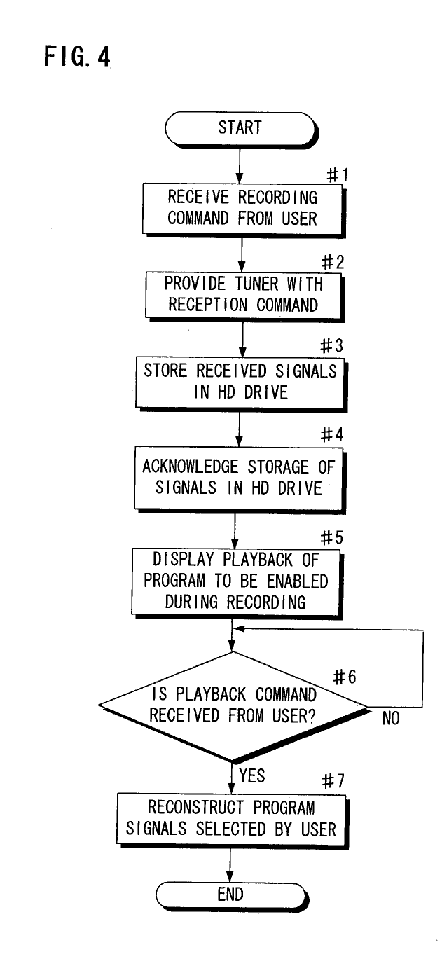

The action of the controller 26 in the broadcast recording apparatus 2 from the reception of the broadcast signals to the playback of their program will now be explained referring to FIG. 4. The action starts with receiving a command of recording the program from a user (#1) and providing the tuner 21 with a command signal for a corresponding channel of the program (#2). In response to the command signal, the broadcast signals received by the tuner 21 are stored in the HD drive 30 (#3). As the storage of the broadcast signals in the HD drive 30 is confirmed (#4), a message that the playback of the program has been enabled is displayed on the monitor 3 (#5). The message to be displayed on the monitor 3 may indicate the length of the program which has been received (and recorded) and can thus be played back in accordance with the timing data for the actual playback speed contained in the broadcast signals. Then, when a playback command is received from the user (yes at #6), the broadcast signals of the program are read out from the HD drive 30 and decoded by the decoder 23 (#7).

As set forth above, the controller 26 according to the present invention allows the broadcast signals which have been transmitted at a speed different from the actual program playback speed to be temporarily saved in the HD drive 30 and when desired, retrieved for decoding and playing back. Accordingly, as the broadcast signals are saved or recorded at a speed faster than the actual program playback speed, their recording can be minimized in the time consumption hence ensuring the energy saving. In particular, the recording of an SD program which is higher in the signal compression will significantly be reduced in the time consumption. Also, the broadcast signals of an HD program transmitted over empty spaces at the frequency band can also be recorded rapidly. The recorded program may be taken up or forwarded for playback. Moreover, the broadcast signals transmitted at a lower speed than the actual program playback speed can equally be recorded. This permits the broadcast signals from a station to be minimized in the occupying size of each program data (sub-channel) and thus to carry a more number of programs in a multiplexing form. When the broadcast signals are intermittently transmitted before joined according to the timing data for playback, other programs may be inserted into empty spaces between the existing programs for recording and playback.

As the broadcast signals are transmitted at a speed different from the actual program playback speed, they may not be received and played back by any other apparatus equipped without the above arrangement. In such any other apparatus, the broadcast signals remain unrecorded as if they have been scrambled and can thus be protected from illegal recording or playback. Also, as the broadcast signals are temporarily saved in the HD drive 30 before read out for playback in any desired time, their recording and playback advantages can be emphasized particularly at midnight periods. Additionally, in case that the program is repeatedly broadcasted, any reception (or transmission) error in its broadcast signals can be compensated quickly by repeating of the recording. Moreover, as the controller 26 confirms the reception and storage in the HD drive 30 of the broadcasting signals and notifies the user of the length of the program which can be played back, it permits the user to acknowledge the availability and enjoy the versatility of the system.

As the present invention is not limited to the foregoing embodiments, various changes and modifications may be made without departing from the scope of the invention. For example, the steps #4 and #5 shown in FIG. 4 may be eliminated. Since the broadcast recording apparatus 2 has the HD drive 30 arranged for recording and playing back the digital signals at fast speeds, it allows the user to conduct an action of follow-up playback just after the start of recording thus improving the versatility of the system. Also, the encoding and decoding of video/audio signals is not limited to the MPEG-2 standards but may be based on any other available standards.

What is claimed is:

1. A digital broadcast recording apparatus having a receiver which receives digital broadcast signals which have been encoded and transmitted from a broadcast station, a storing means which stores the broadcast signals received by the receiver, and a decoder which decodes the broadcast signals stored in the storing means, the digital broadcast recording apparatus comprising:
the digital broadcast signals being transmitted at a speed which is different from an actual playback speed of the program and containing a timing data for the actual playback speed,
a storage controlling means which directs the storing means to temporarily store the broadcast signals received by the receiver; and
a playback controlling means which reconstructs the broadcast signals stored in the storing means with the use of the timing data and directs the decoder to decode the broadcast signals, wherein the broadcast signals are temporarily stored in the storing means and when desired, can be reconstructed for playback.

2. A digital broadcast recording apparatus according to claim 1, wherein the digital broadcast signals are encoded and compressed at the station and transmitted continuously or intermittently over empty spaces in a frequency band assigned to the station.

3. A digital broadcast recording apparatus according to claim 1, further comprising a notifying means which confirms the storage of the broadcast signals in the storing means and notifying a user, during the recording, of the length of the program which can be played back.

4. A digital broadcast recording apparatus according to claim 1, further comprising an entry means which allows a user to enter various commands which include a recording command and a playback command.

5. A digital broadcasting system including a digital broadcast apparatus having an encoder which encodes video and audio signals of each program to digital forms and a transmitting means which transmits the digital signals produced by the encoder, and a digital broadcast recording apparatus having a receiver which receives the digital signals from the digital broadcast apparatus, a storing means which stores the digital signals received by the receiver, and a decoder which decodes the digital signals stored in the storing means, the system comprising:
the digital signals being transmitted from the transmitting means at a speed which is different from an actual playback speed of the program, the digital signals containing a timing data for the actual playback speed, and
the digital broadcast recording apparatus including a storage controlling means which directs the storing means to temporarily store the broadcast signals received by the receiver, and a playback controlling means which reconstructs the broadcast signals stored in the storing means with the use of the timing data and directs the decoding means to decode the broadcast signals, wherein the broadcast signals are temporarily stored in the storing means and when desired, can be reconstructed for playback.

6. A digital broadcasting system according to claim 5, wherein the digital broadcast signals are transmitted continuously or intermittently over empty spaces in a frequency band assigned to the station.
